(19) United States
(12) Patent Application Publication
(10) Pub. No.: US 2013/0300372 A1
(43) Pub. Date: Nov. 14, 2013

(54) ENERGY STORE AND METHOD FOR DISCHARGING AND CHARGING AN ENERGY STORE

(71) Applicants: Christian Brunhuber, Auerbach (DE); Wolfgang Menapace, Erlangen (DE); Nicolas Vortmeyer, Erlangen (DE)

(72) Inventors: Christian Brunhuber, Auerbach (DE); Wolfgang Menapace, Erlangen (DE); Nicolas Vortmeyer, Erlangen (DE)

(21) Appl. No.: 13/980,089

(22) PCT Filed: Jan. 17, 2012
(86) PCT No.: PCT/EP2012/050604

§ 371 Date: Jul. 17, 2013

(30) Foreign Application Priority Data
Jan. 31, 2011 (EP) 11152648.9

(51) Int. Cl. H01M 8/18; H02J 7/00

(52) U.S. Cl. CPC H01M 8/188; H02J 7/0068
USPC 320/128; 429/402

(57) ABSTRACT

An energy store includes a rechargeable primary energy store having a first electrode which generates anions and which conducts anions, a second electrode which accepts anions and/or which conducts anions, an electrolyte which is arranged between the first electrode and the second electrode and which conducts anions and is embodied as a solid, and a first redox pair which forms the second electrode or is in contact with same and which includes an oxidation reactant and an oxidation product. The store includes at least one storable second oxidation reactant that belongs to a second redox pair and a secondary energy store which is designed as a store for the second oxidation reactant. A connecting line is provided between the primary energy store and the secondary energy store, the connecting line allowing the second oxidation reactant to be conducted from the primary energy store to the secondary energy store and back.

### CROSS REFERENCE TO RELATED APPLICATIONS

This application is the US National Stage of International Application No. PCT/EP2012/050604 filed Jan. 17, 2012 and claims benefit thereof, the entire content of which is hereby incorporated herein by reference. The International Application claims priority to the European application No. 11152648.9 EP filed Jan. 31, 2011, the entire contents of which is hereby incorporated herein by reference.

### FIELD OF INVENTION

The present invention relates to an energy store for storing and emitting electrical energy. In addition, the invention relates to a method for discharging and charging such an energy store.

### BACKGROUND OF INVENTION

Energy stores for storing and emitting electrical energy are, for example, of great importance for many mobile applications. While the storage capacity of current energy stores is sufficient for the storage of electrical energy for the operation of smaller devices such as cell phones, portable computers, etc., energy stores for the storage of electrical energy for larger applications such as, for example, electrically powered vehicles are still fraught with imperfections which preclude their successful use in a commercial context. In particular, the storage capacity of the batteries used does not yet meet the desired requirements. Although, for example, lithium ion batteries achieve good results for use in cell phones or computers, for instance, they are not wholly suitable for electric vehicles with their high energy requirements. The storage capacity of lithium ion batteries is a limiting factor for the range of an electric vehicle. As the size of the battery in the vehicle cannot be increased at will, the range remains limited.

In the automotive field in particular, systems are also known in which the energy necessary for propulsion is stored in the form of hydrogen. By means of a fuel cell the hydrogen is then converted into electric current with which the engine can be driven.

For such technology, however, the construction of a fueling station network for hydrogen is necessary, making the introduction of this technology expensive, in particular with regard to the stringent safety requirements for fueling stations due to the risk of explosion.

### SUMMARY OF INVENTION

Compared with this prior art, the object of the present invention is to provide an advantageous energy store and an advantageous method for discharging and charging an energy store. In addition, an object of the present invention is to provide an advantageous electrical system with an electrical load.

The above objects are achieved by the features of the independent claim(s). The dependent claims contain advantageous embodiments of the invention.

An energy store according to the invention comprises a rechargeable primary energy store and a secondary energy store. The primary energy store comprises a first electrode which generates anions and which conducts anions, a second electrode which accepts anions and/or which conducts anions and an electrolyte typically designed as solid matter which is arranged between the first electrode and the second electrode and which conducts anions. In addition, the primary energy store comprises a first redox pair which forms the second electrode or is in contact with same and which comprises an oxidation reactant and an oxidation product. Furthermore, the energy store according to the invention comprises at least one storable second oxidation reactant that belongs to a second redox pair. The secondary energy store is designed as a store for the second oxidation reactant.

Between the primary energy store and the secondary energy store there is a connecting line allowing the second oxidation reactant to be conducted from the primary energy store to the secondary energy store and back. A metal and its oxide or two different oxidation states of a metal, for example, can be used as the first redox pair.

The second oxidation reactant may in particular be gaseous. A suitable second oxidation reactant is, for example, hydrogen. By means of a compressor present between the primary energy store and the secondary energy store for compressing the secondary oxidation reactant a particularly high storage capacity can be achieved for the gaseous oxidation reactant in the second energy store. For the storage of a gaseous second oxidation reactant in particular there may be a high-pressure gas reservoir or a metal-hydride storage unit.

According to the invention a rechargeable battery, the design of which corresponds to a fuel cell, in particular a solid oxide fuel cell (SOFC), is therefore operated in an additional operating mode as a fuel cell or electrolyzer for a redox pair such as, for example, H₂O/H₂. In the battery electrical energy is stored in the form of a typically solid, but sometimes also liquid redox pair, wherein the redox pair in the fully charging state only comprises the reduced portion, in other words the oxidation reactant, and in the discharging state the oxidized part, in other words the oxidation product. To emit energy the oxidation reactant is, for example, oxidized by means of atmospheric oxygen, wherein the atmospheric oxygen is ionized by the first electrode, the oxygen ions are conducted via the first electrode to the electrolyte permeable for the oxygen ions and after passage through the electrolyte oxidize the oxidation reactant.

The oxidation reactant can be either the material of the second electrode itself or a material in contact with said electrode. In the latter case, the second electrode conducts anions. It should be noted here that the use of atmospheric oxygen for oxidation is only chosen as an illustrative example and that instead of oxygen ions, use can also be made of other anions in principle.

When the oxidation reactant of the first redox pair has fully oxidized and no more current flow based on further oxidation of this redox pair is therefore possible, in the additional operating mode the oxidation reactant of a second oxidation pair, for example hydrogen, can be supplied to the second electrode, the battery then operating as a fuel cell. On the second electrode oxidation of the second oxidation reactant then takes place with the emission of electrons which are conducted back to the first electrode via a circuit. In this way, emission of electricity from the energy store can be extended until the second oxidation reactant has been exhausted.

To charge the energy store or recharge the energy store, the first and second electrode are connected to a power supply, the polarity being selected such that the material of the first redox pair is reduced on account of the power supply. After the material of the first redox pair has been completely reduced and the primary energy store has therefore been recharged, in the additional operating mode an oxidation product of the second redox pair can be supplied to the second electrode and the battery operated as an electrolyzer. When using hydrogen as a second oxidation reactant, water vapor, for example, can be supplied as an oxidation product.

On account of the current flow through the electrodes, electrolysis of the oxidation product of the second redox pair takes place so that the oxidation reactant of the second redox pair arises, which can then be stored in the second energy store.

The oxidation product of the second redox pair arising during discharging of the energy store need not necessarily be identical to the oxidation product of the second redox pair used for charging. For example, the oxidation product of the second redox pair arising during discharging can be discharged into the environment. To this end the energy store may have an outlet for the discharge of the oxidation product of the second redox pair. If the oxidation product of the second redox pair which arises during discharging is discharged into the environment, an oxidation product of the second redox pair must be newly supplied to charge the energy store. To this end the energy store may have an inlet for the supply of an oxidation product of the second redox pair. The outlet for the discharge of the oxidation product of the second redox pair arising during discharging and the inlet for the supply of the oxidation product of the second redox pair during charging of the energy store may be identical in particular. The embodiment in which the oxidation product of the second redox pair arising during discharging is discharged into the environment is suitable in particular if the oxidation product is environmentally compatible and can be obtained without great expenditure. This is the case, for instance, when hydrogen is used as an oxidation reactant. When atmospheric oxygen is used for oxidation, for example, water vapor is produced as an oxidation product which can be discharged without damage to the environment. In addition, water vapor for introduction into the energy store during charging is available without great expense.

In particular, if the oxidation product arising during discharging of the energy store is not readily environmentally compatible or the oxidation product can only be obtained at great expense during charging of the energy store, it is advantageous if the energy store includes a reservoir for collecting the oxidation product of the second redox pair and a connecting line between the primary energy store and the reservoir which enables the conducting of the second oxidation product from the primary energy store to the reservoir. The oxidation product collected in the reservoir can then be reused while the energy store is being charged.

An electrical system with an electrical load according to the invention is equipped with at least one energy store according to the invention. In particular, the load may be an electrically driven device, for instance an electric motor. In addition, it is advantageous if the energy store is designed to be replaceable, as then a stoppage of electrical consumption during the charging time necessary for the charging of the energy store can be avoided.

The use of an energy store according to the invention enables the system to fall back on an energy store with a high charging capacity, thus permitting the electrical device to have an extended life without recharging the energy store.

In the method according to the invention for discharging and charging an energy store according to the invention, during discharging the primary energy store is first discharged while emitting electrical energy, by the first oxidation reactant being oxidized to the first oxidation product. Then the second oxidation reactant from the secondary energy store is supplied to the primary energy store for the further emission of electrical energy.

This is then oxidized to the oxidation product of the second redox pair on the second electrode. When charging the energy store, first the primary energy store is charged while consuming electrical energy, with the first oxidation product of the first redox pair being reduced to the first oxidation reactant. Then while continuing to consume electrical energy an oxidation product of the second redox pair is supplied to the primary energy store, and is reduced on the second electrode to the second oxidation reactant. The oxidation reactant arising on the second electrode is conducted into the second energy store for storage.

As a result of the primary energy store being operated as an electrolyzer after charging of the primary energy store, the charging capacity of the energy store can be increased. Likewise, as a result of operation as a fuel cell the duration of current output can be extended after discharging of the first energy store.

To increase the storage capacity of the secondary energy store for a given volume, in the case of a gaseous second oxidation reactant compression of the second oxidation reactant before storage in the secondary energy store may take place.

The oxidation product of the second redox pair arising during discharging of the energy store may either be discharged into the environment or conducted to a reservoir and collected there. The latter is advantageous in particular if the oxidation product arising during discharging of the energy store is not environmentally friendly or an oxidation product for charging the energy store cannot be provided without relatively great expense. The oxidation product collected in the reservoir is then available for reuse during charging.

### BRIEF DESCRIPTION OF THE DRAWINGS

Additional features, properties and advantages of the present invention are emerge from the following description of exemplary embodiments with reference to the attached figures.

FIG. 1 shows an example of a primary energy store of the energy store according to the invention.

FIG. 2 shows an energy store according to the invention in highly schematized form.

FIG. 3 shows the energy store from FIG. 2 in a first discharge mode.

FIG. 4 shows the energy store from FIG. 2 in a second discharge mode.

FIG. 5 shows the energy store from FIG. 2 in a first charge mode.

FIG. 6 shows the energy store from FIG. 2 in a second charge mode.

### DETAILED DESCRIPTION OF INVENTION

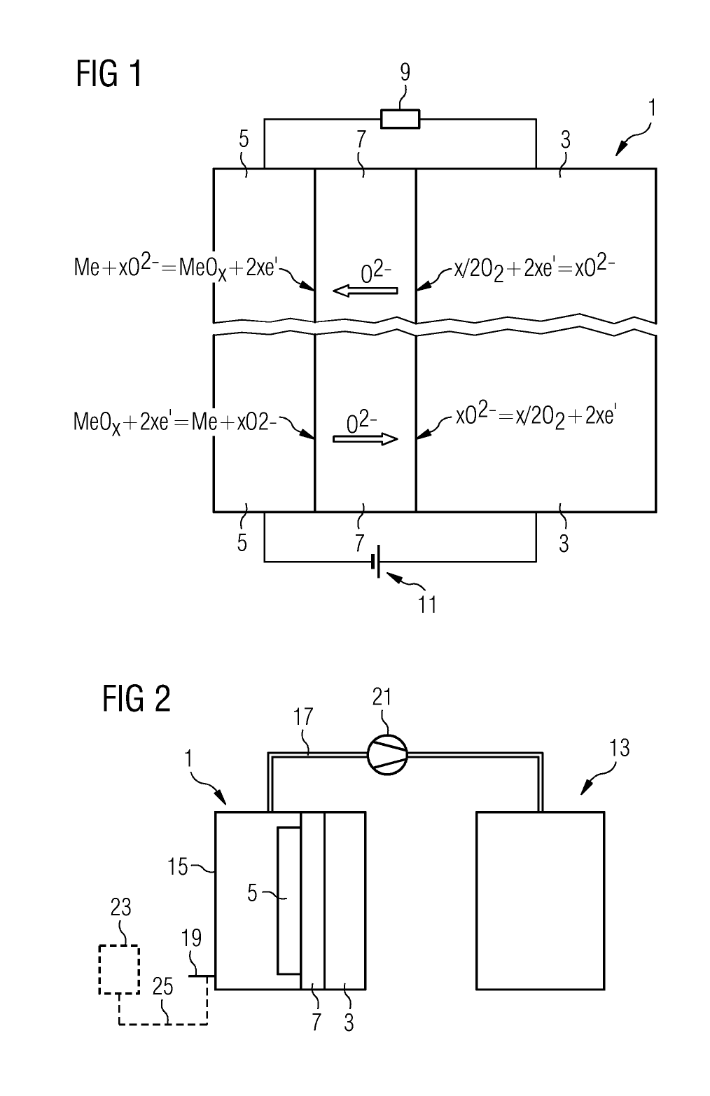

Hereinafter the present invention is explained in more detail on the basis of a highly schematized exemplary embodiment shown in FIGS. 1 to 6. First an explanation is provided of the primary energy store and its operation on the basis of FIG. 1. On the basis of FIGS. 2 to 6 the structure of the energy store according to the invention and its operation is then explained.

The primary energy store of an energy store according to the invention is shown in a highly schematized manner in FIG. 1. Within the framework of the exemplary embodiment a primary energy store is described which is equipped with a metal and a metal oxide as the first redox pair and in which oxidation is performed with the aid of atmospheric oxygen. However, it should be noted here that the first redox pair need not necessarily comprise a metal and a metal oxide but, for example, two metal oxides with different oxidation states or a non-metallic oxidation reactant Likewise, the oxidizing agent need not necessarily be atmospheric oxygen. Other gases or liquids forming anions may also be used in oxidation. Instead of two-fold negatively charged oxygen ions, oxidation then takes place on the basis of another singly or multiply negatively charged ion, for example CO₃²⁻ or PO₄³⁻. In addition, other elements or compounds forming anions, for instance, fluorine or chlorine and fluorine or chlorine compounds, can also be used for oxidation. However, atmospheric oxygen is particularly suitable as an oxidizing agent as it is available everywhere in abundance and does not damage the environment.

In the present exemplary embodiment, the primary energy store 1 comprises a first electrode 3 which is arranged in such a way that air can be fed past it. It is made of an Oxygen Transporting Material, OTM for short, which generates oxygen ions O²⁻ from the atmospheric oxygen and is also able to conduct the oxygen ions. Examples of suitable materials for the first electrode 3, hereinafter referred to as an air electrode, are perovskite (ABO₃) or zirconium oxide, which is doped with scandium oxide or yttrium oxide (ScSZ and YSZ) as well as combinations thereof.

The primary energy store comprises a second electrode which accepts and/or conducts the oxygen ions and which in the present exemplary embodiment consists of a metal, for instance iron, which is oxidized by the oxygen ions. Alternatively, the second electrode 5 may also consist of a material conducting oxygen ions such as, for example, perovskite, which has a sponge-like or scaffold-like structure. In this case, a liquid redox pair may be used into which the second electrode is immersed. As the second electrode in the present exemplary embodiment is made of a redox pair formed by a metal and a metal oxide, wherein depending on the state of charge of the primary energy store it consists of metal, metal oxide or a mixture of both, it is hereinafter referred to as a metal electrode 5.

An electrolyte layer 7 is arranged between the air electrode 3 and the metal electrode 5, and in the present exemplary embodiment is a ceramic membrane transporting oxygen ions. For example, it may be made of a single phase of zirconium oxide which is stabilized with scandium oxide or yttrium oxide. Alternatively mixtures of yttrium oxide which is doped with zirconium oxide and yttrium oxide which is doped with scandium oxide may also be used.

When discharging the primary energy store, oxygen ions O²⁻ are formed from the air fed past the air electrode 3, wherein electrons are absorbed by the oxygen from the material of the air electrode to form anions. The consequent oxygen ions migrate through the electrolyte layer 7 to the metal electrode 5 where they oxidize the metal while emitting electrons. The surfeit of electrons thus arising in the metal electrode is conducted to the air electrode 3 by the interposition of an electrical load 9. The reactions taking place during the discharging process are shown in the upper half of FIG. 1.

The charging process and the reactions taking place at the same time are shown in the lower half of FIG. 1. Instead of an electrical load, a power supply 11 is connected to the electrodes 3, 5 to charge the primary load, wherein the negative terminal is connected to the metal electrode and the positive terminal to the air electrode. By means of the electrons flowing to the metal electrode, the metal oxide is reduced, releasing oxygen ions which migrate through the electrolyte layer 7 to the air electrode 3. In the air electrode 3, which is connected to the positive terminal of the energy source 11, the electrons are emitted by the oxygen ions so that molecular oxygen is formed, which is emitted by the air electrode 3 to the environment. If the metal oxide of the metal electrode 5 is completely reduced to metal, additional charging of the primary energy store is not possible.

In order to then be able to continue to charge the energy store according to the invention even if the metal oxide has been completely reduced, the energy store comprises a secondary energy store 13 which is connected via a gas line 17 to a housing 15, which encloses the metal electrode 5 (cf. FIG. 2). In addition, the housing 15 has an inlet/outlet 19 via which a gas or vapor can be discharged into or out of the inside of the housing 15. For additional charging of the energy store according to the invention, a second, typically gaseous redox pair is used. In the present exemplary embodiment this second redox pair is formed from hydrogen and water vapor. However, other redox pairs, in particular gaseous redox pairs can also be considered. But liquid redox pairs are not ruled out entirely either.

In the present exemplary embodiment water vapor is fed through the inlet/outlet 19 into the inside of the housing 15 for further charging of the energy store according to the invention. At the same time the primary energy store remains connected to the power supply, as shown in the lower half of FIG. 1. Instead of a further reduction of the metal, a reduction of the water vapor introduced into the inside of the housing 15 to hydrogen now takes place, which by means of a compressor 21 arranged in the gas line 17 is introduced into the secondary energy store 13, which in the present exemplary embodiment is designed as a high-pressure gas reservoir. The oxygen ions arising during reduction of the water vapor are in turn forwarded via the electrolyte layer 7 to the air electrode 3 and there converted to molecular oxygen which is discharged into the environment. For additional charging of the energy store according to the invention the primary energy store is therefore used as an electrolyzer for the electrolysis of water vapor. Electrolysis and storage of the hydrogen can take place until the secondary energy store 13 is completely filled with hydrogen. Only then is the energy store according to the invention fully charged.

Although a high-pressure gas reservoir is used in the present exemplary embodiment for the storage of hydrogen, other embodiments are also possible. For example, the secondary energy store can be designed as a metal-hydride storage unit. Likewise, the second redox pair does not need to consist of water vapor and hydrogen. Thus, the hydrogen can be replaced by methane, for example. Likewise, the water vapor can be replaced by another component, for example by hydrogen fluoride. However, the use of water vapor as a component of the redox pair is advantageous from environmental perspectives. In addition, the oxidation product used for charging may be distinguished from the oxidation product arising during discharging. A redox pair within the meaning of the present invention may therefore also comprise more than one oxidation product.

However, it is advantageous if both oxidation products are identical as then a complete material cycle can be realized.

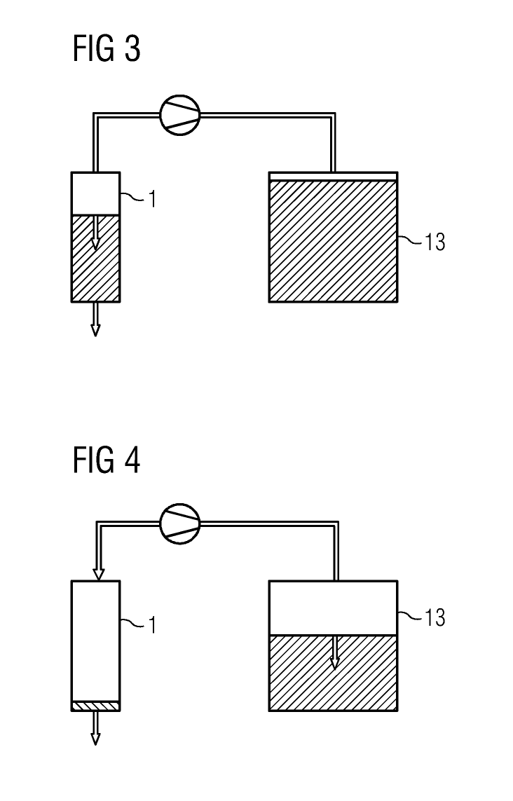

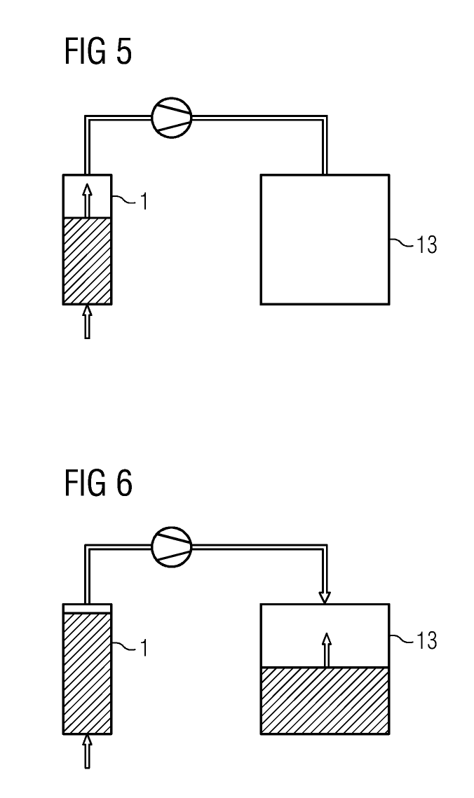

The discharging of a fully charged energy store according to the invention is shown in FIGS. 3 and 4, the complete recharging of the energy store in FIGS. 5 and 6. When discharging the energy store according to the invention, in other words during consumption of electrical energy by a load 9 connected to the electrodes 3, 5 of the primary energy store 1, first the primary energy store is discharged by means of oxidation of the metal electrode 5. This discharge mode is shown in FIG. 3.

If the primary energy store 1 is discharged, hydrogen from the secondary energy store 13 is supplied to the inside of the housing 15, and is oxidized into water vapor on the now oxidized metal electrode 5 by the oxygen ions obtained in the air electrode 3. The water vapor is finally discharged via the inlet/outlet 19 to the environment. This mode of discharge, which is schematically represented in FIG. 4, can be continued until the secondary energy store 13 is unable to discharge any more hydrogen.

To charge the energy store according to the invention, instead of the load 9 a power supply 11 is connected to the primary energy store 1, as shown in the lower half of FIG. 1. With the aid of this power supply, the metal oxide of the metal electrode 5 is reduced to metal. This charging mode is shown in FIG. 5. If a further reduction of the metal electrode 5 is not possible, water vapor is injected into the inside of the housing 15 via the inlet/outlet 19 and is reduced to hydrogen until the secondary energy store 13 has been completely filled. This charging mode is shown in FIG. 6.

In addition to the modifications of the exemplary embodiment already described, further modifications are possible. Thus, for example, a reservoir 23 which is connected via a connecting line 25 to the inside of the housing 15 (shown by a dotted line in FIG. 2) may be available for the water vapor arising during the discharging of the secondary store, in which reservoir 23 the water vapor is collected so that it can be reused when charging the secondary energy store. This embodiment is advantageous in particular if the second redox pair does not contain any water vapor as an oxidation product but an oxidation product which should not be discharged into the environment, whether because it is environmentally damaging or because it is not readily obtainable for recharging the secondary energy store.

The energy store according to the invention is suitable, for example, for mobile applications, in particular for electrically powered vehicles. In this case, the load 9 shown in FIG. 1 is an electric motor. But other mobile or non-mobile electrical systems which have an electrical load such as, for example, an electric motor or other electrically powered devices, may also have an energy store according to the invention for the supply of energy. Mobile medical devices or lamps are conceivable, for example.

In addition, it is possible to design the energy store to be replaceable so that a fully discharged energy store can be replaced by a new, charged energy store. In this way, stoppages can be avoided when charging the energy store. Alternatively, there is the option of such an electrical system having more than one energy store according to the invention, in particular two energy stores.

Then one energy store can be charged while the other energy store supplies the electrical load with power. In particular, the exemplary embodiment with at least two energy stores is practical for stationary electrical systems, whereas the version with a replaceable energy store according to the invention is advantageous in mobile applications.

1-15. (canceled)

16. An energy store, comprising:
a rechargeable primary energy store comprising a first electrode which generates anions and which conducts anions, a second electrode which accepts anions and/or which conducts anions, an electrolyte which is arranged between the first electrode and the second electrode and which conducts anions and is embodied as a solid, and a first redox pair which forms the second electrode or is in contact with same and which comprises an oxidation reactant and an oxidation product;
at least one storable second oxidation reactant that belongs to a second redox pair;
a secondary energy store which is designed as a store for the second oxidation reactant; and
a connecting line between the primary energy store and the secondary energy store, said connecting line allowing the second oxidation reactant to be conducted from the primary energy store to the secondary energy store and back.

17. The energy store as claimed in claim 16, further comprising an outlet for the discharge of the oxidation product of the second redox pair and/or an inlet for the supply of an oxidation product of the second redox pair.

18. The energy store as claimed in claim 16, further comprising a reservoir for collecting the oxidation product of the second redox pair and a connecting line between the primary energy store and the reservoir, said connecting line allowing the second oxidation product to be conducted from the primary energy store to the reservoir.

19. The energy store as claimed in claim 16, wherein the first redox pair comprises a metal and its oxide or two different oxidation states of a metal.

20. The energy store as claimed in claim 16, wherein the second oxidation reactant is gaseous.

21. The energy store as claimed in claim 20, wherein the second oxidation reactant is hydrogen.

22. The energy store as claimed in claim 20, wherein there is a compressor between the primary energy store and the secondary energy store to compress the secondary oxidation reactant.

23. The energy store as claimed in claim 20, wherein the secondary energy store is a high-pressure gas reservoir or a metal-hydride storage unit.

24. An electrical system, comprising:
an electrical load, and
at least one energy store as claimed in claim 16.

25. The electrical system as claimed in claim 24, wherein the electrical load is an electric motor.

26. The electrical system as claimed in claim 24, wherein the energy store is replaceable.

27. A method for discharging and charging an energy store as claimed in claim 16, the method comprising:
during a discharging process, first discharging the primary energy store while emitting electrical energy, by the first oxidation reactant being oxidized to the first oxidation product, and then supplying the second oxidation reactant from the secondary energy store to the primary energy store for the further emission of electrical energy and is oxidized on the second electrode to the oxidation product of the second redox pair, and
during a charging process, first charging the primary energy store while consuming electrical energy, by the first oxidation product of the first redox pair being reduced to the first oxidation reactant, and then with further consumption of electrical energy an oxidation product of the second redox pair is supplied to the primary energy store and is reduced to the second oxidation reactant on the second electrode, and the oxidation reactant arising on the second electrode being conducted to the secondary energy store for storage.

28. The method as claimed in claim 27, wherein a gaseous second oxidation reactant is used and the second oxidation reactant is compressed in the secondary energy store before storage.

29. The method as claimed in claim 27, wherein the oxidation product of the second redox pair arising during discharging is discharged into the environment.

30. The method as claimed in claim 27, wherein the oxidation product of the second redox pair arising during discharging is conducted to a reservoir and collected there.
